(19) United States
(12) Patent Application Publication
(10) Pub. No.: US 2016/0308725 A1
(43) Pub. Date: Oct. 20, 2016

(54) Integrated Community And Role Discovery In Enterprise Networks

(71) Applicant: NEC Laboratories America, Inc., Princeton, NJ (US)

(72) Inventors: LuAn Tang, Pennington, NJ (US); Zhengzhang Chen, Princeton Junction, NJ (US); Ting Chen, Malden, MA (US); Guofei Jiang, Princeton, NJ (US); Fengyuan Xu, Franklin Park, NJ (US); Haifeng Chen, West Windsor, NJ (US)

(21) Appl. No.: 15/098,861

(22) Filed: Apr. 14, 2016

Related U.S. Application Data
(60) Provisional application No. 62/148,232, filed on Apr. 16, 2015.

(51) Int. Cl. H04L 12/24; H04L 29/06

(52) U.S. Cl. CPC H04L 41/12; H04L 63/0421

(57) ABSTRACT

Methods and systems for detecting anomalous communications include simulating a network graph based on community and role labels of each node in the network graph based on one or more linking rules. The community and role labels of each node are adjusted based on differences between the simulated network graph and a true network graph. The simulation and adjustment are repeated until the simulated network graph converges to the true network graph to determine a final set of community and role labels. It is determined whether a network communication is anomalous based on the final set of community and role labels.

### RELATED APPLICATION INFORMATION

This application claims priority to 62/148,232, filed on Apr. 16, 2015, incorporated herein by reference in its entirety.

### BACKGROUND

1. Technical Field

The present invention relates to computer and network security and, more particularly, to integrated discovery of node community and role in such networks.

2. Description of the Related Art

Enterprise networks are key systems in corporations and they carry the vast majority of mission-critical information. As a result of their importance, these networks are often the targets of attack. Communications on enterprise networks are therefore frequently monitored and analyzed to detect anomalous network communication as a step toward detecting attacks.

However, accurate and effective detection is difficult if the system lacks knowledge of community and roles. Community represents the working group that a machine belongs to, while role represents the function of the machine (e.g., as an email server, as a data server, as a personal desktop, etc.). It often isn't possible for users to provide an accurate picture of community and role for an entire network.

Existing approaches to community and role detection treat the questions separately, for example detecting roles without taking community structures into account and detecting a node's community while ignoring its role, when in fact communities and roles are tightly coupled and cannot be separated in real networks.

### SUMMARY

A method for detecting anomalous communications includes simulating a network graph based on community and role labels of each node in the network graph based on one or more linking rules. The community and role labels of each node are adjusted based on differences between the simulated network graph and a true network graph. The simulation and adjustment are repeated until the simulated network graph converges to the true network graph to determine a final set of community and role labels. It is determined whether a network communication is anomalous based on the final set of community and role labels.

A system for detecting anomalous communications includes a community and role detection module having a processor configured to simulate a network graph based on community and role labels of each node in the network graph based on one or more linking rules, to adjust the community and role labels of each node based on differences between the simulated network graph and a true network graph, and to repeat said simulation and adjustment until the simulated network graph converges to the true network graph to determine a final set of community and role labels. An anomaly detection module is configured to determine whether a network communication is anomalous based on the final set of community and role labels.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram directed to an automatic security intelligence system architecture in accordance with the present principles.

FIG. 2 is a block/flow diagram directed to an intrusion detection engine architecture in accordance with the present principles.

FIG. 3 is a block/flow diagram directed to a network analysis module architecture.

FIG. 4 is directed to a network graph representing communities and roles of nodes in accordance with the present principles.

FIG. 5 is a block/flow diagram of a method of discovering community and role memberships and detecting anomalies in accordance with the present principles.

FIG. 6 is a block/flow diagram of a method of detecting anomalies in accordance with the present principles.

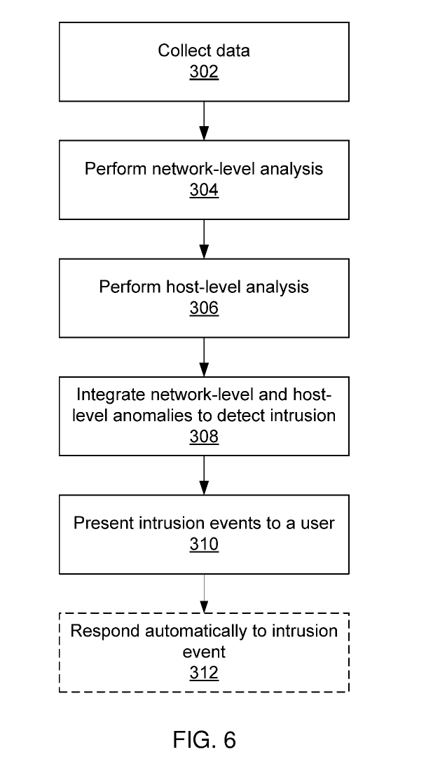

FIG. 7 is a block diagram of a system for discovering community and role memberships and detecting anomalies in accordance with the present principles.

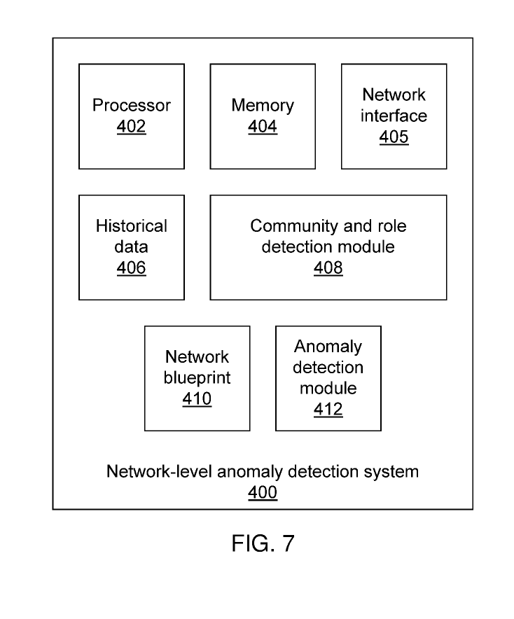

FIG. 8 is a block diagram of a processing system in accordance with the present principles.

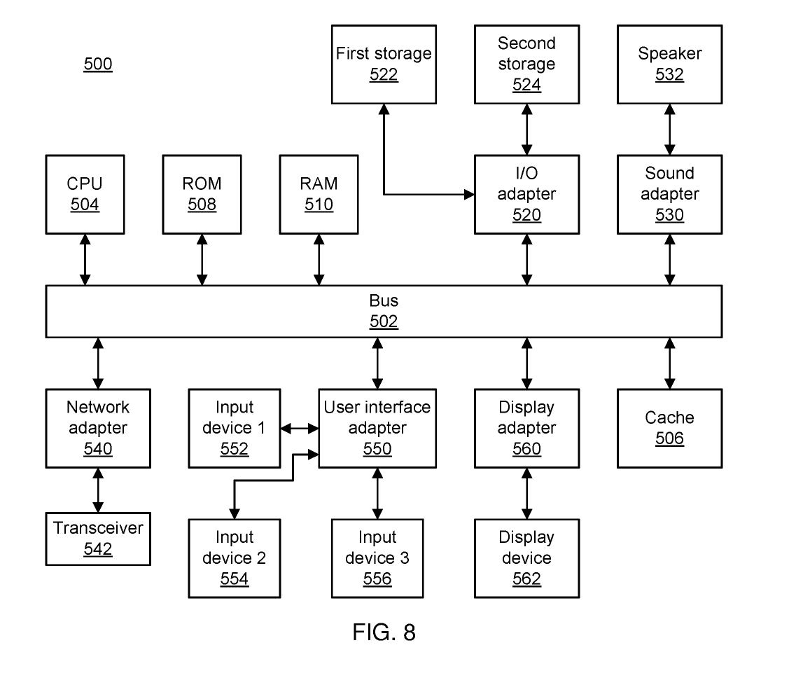

### DETAILED DESCRIPTION OF PREFERRED EMBODIMENTS

In accordance with the present principles, the present embodiments detect communities and roles in a network in an integrated manner. In particular, every node in a network is associated not only with community membership, but also with role membership, so that the system can capture both community and role structures simultaneously. When two nodes attempt to interact (e.g., when forming an edge between two nodes on the graph representing the network), both community and role memberships are considered when determining how probable the link is and, thus, whether the link can be considered anomalous. The community and role of each node is determined, in one embodiment, according to Gibbs sampling-based learning.

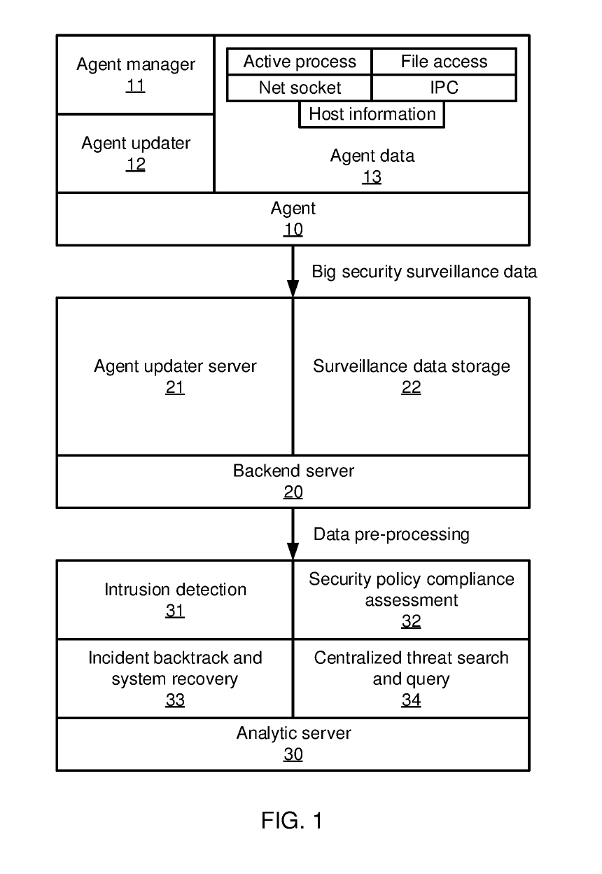

Referring now in detail to the figures in which like numerals represent the same or similar elements and initially to FIG. 1, an automatic security intelligence system (ASI) architecture is shown. The ASI system includes three major components: an agent 10 is installed in each machine of an enterprise network to collect operational data; backend servers 200 receive data from the agents 10, pre-process the data, and sends the pre-processed data to an analysis server 30; and an analysis server 30 that runs the security application program to analyze the data.

Each agent 10 includes an agent manager 11, an agent updater 12, and agent data 13, which in turn may include information regarding active processes, file access, net sockets, number of instructions per cycle, and host information. The backend server 20 includes an agent updater server 21 and surveillance data storage. Analysis server 30 includes intrusion detection 31, security policy compliance assessment 32, incident backtrack and system recovery 33, and centralized threat search and query 34.

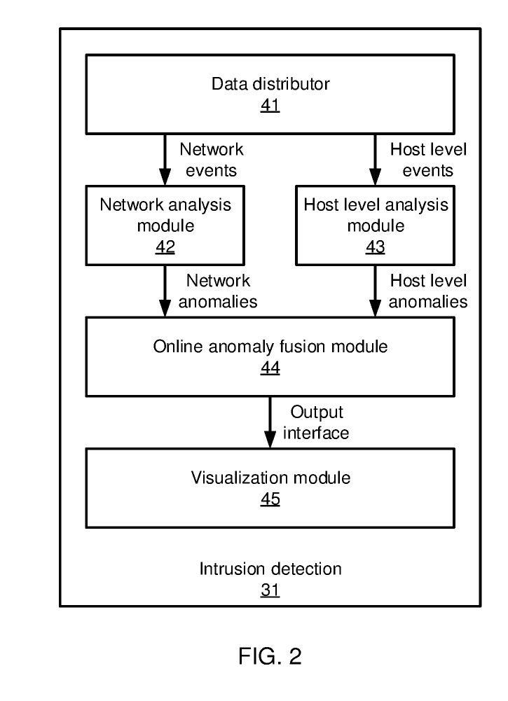

Referring now to FIG. 2, additional detail on intrusion detection 31 is shown. There are five modules in an intrusion detection engine: a data distributor 41 that receives the data from backend server 20 and distributes the corresponding to network level module 42 and host level module 43; network analysis module 42 that processes the network communications (including TCP and UDP) and detects abnormal communication events; host level analysis module 43 that processes host level events, including user-to-process events, process-to-file events, and user-to-registry events; anomaly fusion module 44 that integrates network level anomalies and host level anomalies and refines the results for trustworthy intrusion events; and visualization module 45 that outputs the detection results to end users.

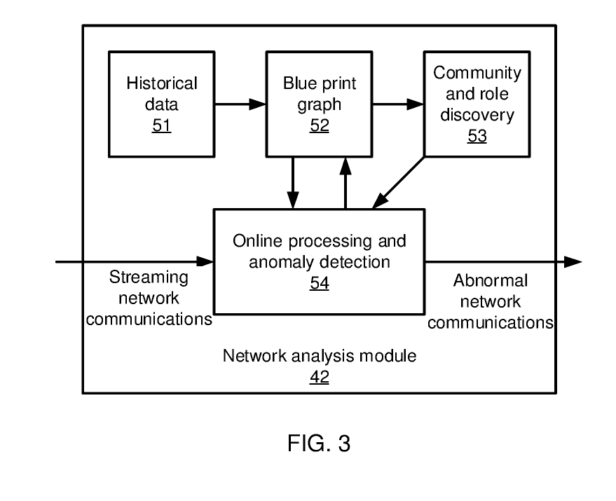

Referring now to FIG. 3, additional detail on network analysis module 42 is shown. The network analysis module 42 includes at least three major components: a blue print graph 52 that is a heterogeneous graph constructed from historical dataset 51 of the communications in the enterprise network, with the nodes of the graph representing machines on the enterprise network and edges representing the normal communication patterns among the nodes; a community and role discovery module 53 that automatically discovers the communities and roles of each node in the blueprint graph; and an online processing and anomaly detection module 54 that takes incoming streaming network communication events as input, conducts analysis based on the blueprint graph and community/role information, and outputs detected abnormal network communications (i.e., network anomalies). The online processing and anomaly detection module 52 also updates the blueprint graph.

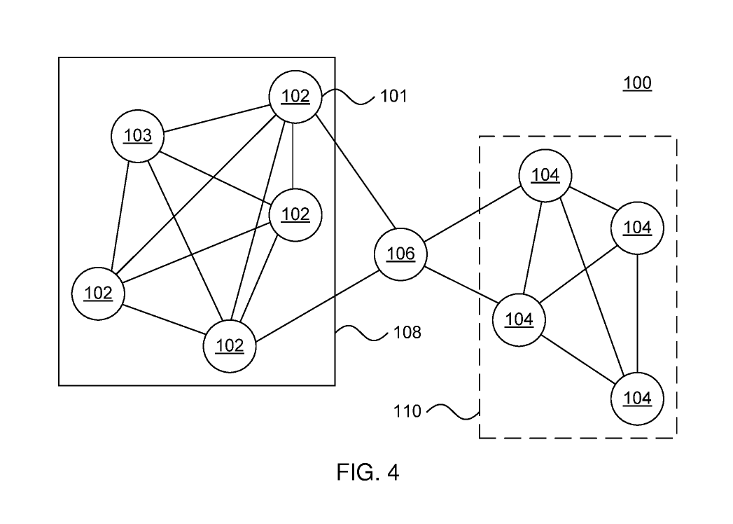

Referring now to FIG. 4, an exemplary computer network 100 is illustratively depicted in accordance with one embodiment of the present principles. The network 100 is formed from a set of nodes 101, each of which has a role and a community. In the embodiment of FIG. 1, the nodes marked 102 have a community 108, while the nodes marked 104 have a community 110. It should be noted that the network graph 100 does not represent a physical network, but instead represents communications between the nodes 101, with each edge of the graph representing a communications link. There is nothing in principle stopping a node 102 from community 108 from forming a link with a node 104 in community 110. However, the present embodiments will consider the communities and roles of the nodes 101 in determining whether that link is anomalous. The nodes 101 are described herein as representing individual devices, but it should be understood that in some embodiments a single node 101 may incorporate multiple devices and, conversely, a single device may host multiple nodes 101. Similarly, a single node 101 may occupy multiple roles.

It should be understood that nodes 101 in different communities will have a low likelihood of interaction with one another (e.g., a low probability of forming a link). However, one exception is in the case of a node 106 that has a specific role, such as a router or bridge. In this case, the node 106 may belong to one, both, or neither of the communities 108 and 110, and its role as an intermediary between those two communities will strongly influence its likelihood of forming connections with other nodes 101. This may be referred to as a background role-based connection. Note though that communities need not be identified with physical network segments—a community may instead simply represent for example a department or other organizational structure that communicates frequently within itself and relatively rarely with other departments.

Similarly, when two nodes are in the same community they will interact with a higher probability, but roles are also a strong factor. For example, a file server 103 within community 108 may interact more frequently with user terminals 102 than those nodes 102 interact with one another. This may be referred to as a within-community role-based connection.

Referring now to FIG. 2, a method for detecting anomalous links is shown. Block 202 generates an adjacency matrix representation of a blueprint graph, which is a heterogeneous graph constructed from a historical dataset of communications in the network 100, with nodes 101 representing physical devices on an enterprise network and edges reflecting the normal communication patterns among the nodes 101. For each pair of nodes in the adjacency matrix, block 204 generates community and role labels. The initial labels generated by block 204 may be random or may be generated according to any initial information that is available (e.g., based on known software installed on respective nodes 101 or based on an existing network map).

Block 206 then simulates the interactions of node pairs between different communities and roles. The simulation is based on a set of rules for known interactions between community members and according to roles. For example, the nodes 104 marked by the labels as being members of community 110 will have a simulated link between them. In another example, server/client role relationships can be represented as links. This simulation is used to generate a simulated graph blueprint. Block 207 uses the simulated graph blueprint to form a synthetic adjacency matrix for the simulated graph.

If there are discrepancies between the adjacency matrix and the synthetic adjacency matrix, block 208 adjusts the community and role labels to bring the simulated links closer to the actual links in the blueprint graph. Block 210 then determines whether the synthetic matrix has converged with the real adjacency matrix, such that the links in the simulated graph match those of the blueprint graph. Convergence may be satisfied when the synthetic adjacency matrix is identical to the real adjacency matrix or may alternatively be based on a similarity metric for the matrices, where convergence is reached when the similarity metric is below a threshold. If so, block 212 uses the detected community and role labels to determine whether there is an anomaly. If not, processing returns to block 206 until the synthetic matrix does converge.

In one example of anomaly detection, consider a first node n₁ that has the role label of, “database server,” and a community label of, “system team.” A second node n₂ has the role label of, “email server,” and the community label of, “operational team.” If a new network connection between n₁ and n₂ is detected, the system can determine that the database server of one team will rarely have legitimate need to communicate with the email server of another team (with such information being set by the domain user). Block 212 may then determine that an intrusion has occurred.

The assignment of labels in block 204 may be performed as a respective community membership vector πᵢ and a respective role membership vector θᵢ for each node i. When a pair of nodes (i,j) attempts to form a link, their community and role membership assignments Zᵢⱼ^{c},Zⱼᵢ^{c},Zᵢⱼ^{r},Zⱼᵢ^{r} are drawn according to a multinomial distribution parameterized by their membership distribution vectors, with Zᵢⱼ^{c} being the community assignment of node i for the pair of nodes (i,j) and Zᵢⱼ^{r} being the role assignment of node i for the pair of nodes (i,j). The question of whether a link is formed is represented as a Bernoulli event based on the community and role assignments of the two nodes and an interaction parameter B that characterizes the interaction probability between two community and role assignment tuples, for example (Zᵢⱼ^{c}, Zᵢⱼ^{r}).

The parameters π, θ, and B are treated as random variables, with Beta prior on each entry of B. The term B_{δpq} is a Bernoulli distribution, and πᵢ and θᵢ have a multinomial distribution with Dirichlet priors. The present model can then be summarized as follows:

For each entry (δ, p, q) in B:
draw B_{δpq}˜Beta(ξ_{δpq}¹,ξ_{δpq}²).

For each node i:
Draw a community membership vector Zᵢⱼ^{c}˜Dirichlet(α^{c})
Draw a role membership distribution vector Zⱼᵢ^{c}˜Dirichlet(α^{r})

For each node pair (i,j):
Draw node i's community Zᵢⱼ^{c}˜Multinomial(πᵢ)
Draw node j's community Zⱼᵢ^{c}˜Multinomial(πⱼ)
Draw node i's role Zᵢⱼ^{r}˜Multinomial(θᵢ)
Draw node j's role Zⱼᵢ^{r}˜Multinomial(θⱼ)
Draw link Eᵢⱼ˜Bernoulli (B_{δ(Z}_{ᵢⱼ}_{^{c}}_{,Z}_{ⱼᵢ}_{^{c}}_{),Z}_{ᵢⱼ}_{^{r}}_{,Z}_{ⱼᵢ}_{^{r}})

Under the above generative model, when the adjacency matrix Eᵢⱼ is observed, the posterior distribution of hidden variables, such as membership vectors, can be inferred. Given the network communications data, the posterior distribution and, in particular, the posterior mean, of the variables in the model are inferred. Due to the complicated integrals over hidden states in the posterior inference, exact inference is intractable. The present embodiments therefore employ Gibbs sampling inference, though it should be understood that other types of inference may be used instead.

In Gibbs sampling, a Markov chain is maintained. The chain sequentially reaches its next state by sampling a variable from its distribution when conditioned on current values of all of the other variables. When the Markov chain approaches an equilibrium distribution, the subsequent samples are generated from the target distribution. Using collapsed Gibbs sampling, direct samples of the Dirichlet membership variables π and θ are avoided by integrating those variable out. Thus, only the membership assignments of a pair of nodes (i,j) are sampled at a time according to the pair's conditional distribution. The conditional distribution P is therefore computed, representing the community and role assignments of the pair of nodes (i,j) given the adjacency matrix Eᵢⱼ and current assignments of the other node pairs. The conditional distribution P is defined as:

$$P ∝ \frac{{( {n}_{δ ( a , b ) pq +}^{- ij} + {ξ}^{1} )}^{{E}_{ij}} {( {n}_{δ ( a , b ) pq -}^{- ij} + {ξ}^{2} )}^{1 - {E}_{ij}}}{{n}_{δ ( a , b ) pq +}^{- ij} + {n}_{δ ( a , b ) pq -}^{- ij} + {ξ}^{1} + {ξ}^{2}} ( {h}_{ia}^{- ij} + {α}^{c} ) ( {h}_{jb}^{- ij} + {α}^{c} ) ( {m}_{ip}^{- ij} + {α}^{r} ) ( {m}_{ip}^{- ij} + {α}^{r} )$$

where a=Zᵢⱼ^{c}, b=Zⱼᵢ^{c}, p=Zᵢⱼ^{r}, q=Zⱼᵢ^{r}, hᵢₐ is the count of the node i assigned to community a, mᵢₚ is the count of the node i assigned to role b, n_{δ(a,b)pq+}^{-ij} is a count of linked node pairs with community assignments a and b and role assignments p and q, n_{δ(a,b)pq-}^{-ij} is a count of unlinked node pairs with community assignments a and b and role assignments p and q, ξ¹ and ξ² are scalar Beta hyperparameters for (k, p, q) in the interaction tensor B.

It is worth noting that the conditional distribution P is proportional to two parts: the rate of link/non-link given the community and role assignments of the two nodes, and the ratio (after normalization) of community and role membership assignments of both nodes. Both parts are calculated by excluding their current assignments.

The Markov chain can then be initialized by a given community and role membership assignments for all node pairs. The chain can be run by sequentially re-sampling assignments of each pair of nodes conditioned on the rest. Once the assignments of a pair of nodes are updated, the counters n, m and h are also updated. After enough iterations, the Markov chain approaches the equilibrium distribution. The subsequent samples of the community and role assignments can be collected to estimate the posterior distribution of the variables.

The community membership of node i is Dirichlet distributed, and its mean at a^{th} dimension is:

$${π}_{ia} = \frac{( {h}_{ia} + {α}^{c} )}{{\sum }_{a = 1}^{{K}^{c}} {h}_{ia} + {K}^{c} {α}^{c}}$$

where K^{c} is the number of communities and a′ is the Dirichlet hyperparameter for πᵢ. The role membership of the node i is also Dirichlet distributed, and its mean at the p^{th} dimension is given by:

$${θ}_{ip} = \frac{( {m}_{ip} + {α}^{r} )}{{\sum }_{p = 1}^{{K}^{r}} {m}_{ip} + {K}^{r} {α}^{r}}$$

where K^{r} is the number of roles and α^{r} is the Dirichlet hyperparameter for θᵢ. The interaction tensor B is Beta distributed, with the mean of each entry being estimated by:

$${B}_{kpq} = \frac{{n}_{kpq +} + {ξ}^{1}}{{n}_{kpq +} + {n}_{kpq -} + {ξ}^{1} + {ξ}^{2}}$$

Blocks 206 and 207 therefore compute the conditional distribution for each pair of nodes (i, j) and block 208 determines πᵢₐ, θᵢₚ, and B_{kpq}.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Referring now to FIG. 3, a method of performing intrusion detection based on an integrated network-level analysis that includes both community and role information is shown. Block 302 collects data from agents installed on each of the nodes 101. The agents collect information regarding each node's activities, including for example host-level activities (e.g., user-to-process events, process-to-file events, user-to-registry events, etc.) and network-level activities (e.g., TCP and UDP connections with other nodes 101 on the network 100).

Block 304 performs a network-level analysis using the collected information. The network-level analysis is described in greater detail above and integrates both node community membership and node role membership to detect anomalous communications. Block 306 performs a host-level analysis based on the collected information to determine whether anomalous behavior has occurred locally within a single node 101.

Block 308 integrates the network-level and host-level anomalies to provide intrusion detection events. This may include further contextual analysis to detect interactions between network-level and host-level anomalies, for example noting that certain host-level and network-level anomalies may have greater import when occurring together. Block 310 then presents the detected intrusion events to a user for review and for further action. In some embodiments, block 312 may automatically respond to the intrusion detection event. The response may include, for example, blocking certain network-level communications, restricting access on the level of an individual host, changing security policies, and providing alerts to interested parties, such as a system administrator. Block 312 may consider the specific intrusion information determined by block 308 to determine a best course of action.

Referring now to FIG. 4, a network-level anomaly detection system 400 is shown. The detection system 400 includes a hardware processor 402 and a memory 404, as well as a network interface 405. The system 400 further includes certain functional modules that may, in some embodiments, be implemented as software that is stored in the memory 404 and executed by processor 402. In other embodiments, the functional modules may be implemented as one or more discrete hardware components, for example in the form of an application-specific integrated chip or field programmable gate array.

The system 400 collects historical data 406 regarding the network 100 via the network interface 405 and stores the historical data 406 in the memory 404. This historical data 406 includes information that reflects communications between nodes 101 on the network 100 and is provided by agents at the individual nodes 101 that report what each respective node 101 is doing. The historical data 406 is used to construct a blueprint graph 410 of the network 100, with nodes 101 of the blueprint graph representing individual hosts on the network 100 and edges representing normal communications between the nodes 101.

A community and role detection module 408 automatically discovers the community and role memberships of each node 101 in the network 100 as described in detail above. The community and role detection module 408 uses the processor 402 to analyze the blueprint graph 410 and provides membership vectors θ and π. Anomaly detection module 412 uses the membership vectors and the blueprint graph to review incoming information about current network communications and to determine whether a given communication is anomalous. The anomaly detection module 412 furthermore uses the incoming network communications to make adjustments to the blueprint graph 410, which in turn may lead to adjustments in the community and role memberships.

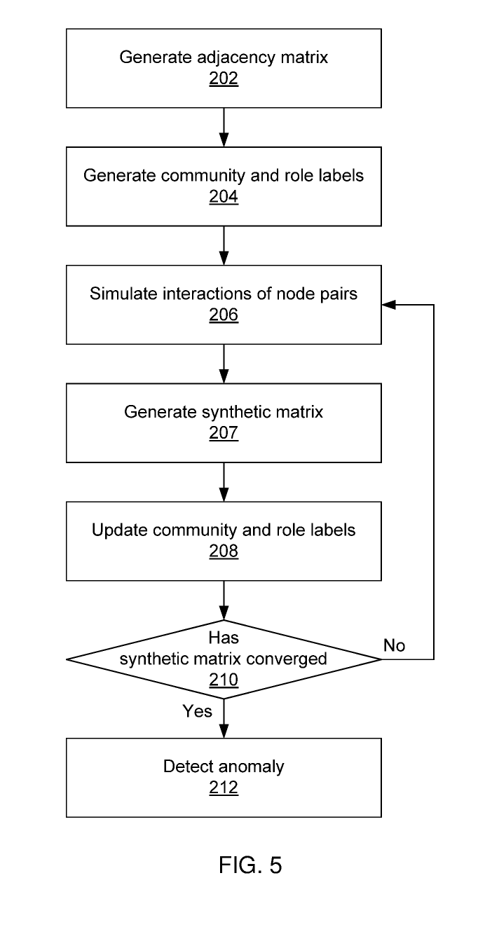

Referring now to FIG. 5, an exemplary processing system 500 is shown which may represent the network-level anomaly detection system 400. The processing system 500 includes at least one processor (CPU) 504 operatively coupled to other components via a system bus 502. A cache 506, a Read Only Memory (ROM) 508, a Random Access Memory (RAM) 510, an input/output (I/O) adapter 520, a sound adapter 530, a network adapter 540, a user interface adapter 550, and a display adapter 560, are operatively coupled to the system bus 502.

A first storage device 522 and a second storage device 524 are operatively coupled to system bus 502 by the I/O adapter 520. The storage devices 522 and 524 can be any of a disk storage device (e.g., a magnetic or optical disk storage device), a solid state magnetic device, and so forth. The storage devices 522 and 524 can be the same type of storage device or different types of storage devices.

A speaker 532 is operatively coupled to system bus 502 by the sound adapter 530. A transceiver 542 is operatively coupled to system bus 502 by network adapter 540. A display device 562 is operatively coupled to system bus 502 by display adapter 560.

A first user input device 552, a second user input device 554, and a third user input device 556 are operatively coupled to system bus 502 by user interface adapter 550. The user input devices 552, 554, and 556 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 552, 554, and 556 can be the same type of user input device or different types of user input devices. The user input devices 552, 554, and 556 are used to input and output information to and from system 500.

Of course, the processing system 500 may also include other elements (not shown), as readily contemplated by one of skill in the art, as well as omit certain For example, various other input devices and/or output devices can be included in processing system 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 500 are readily contemplated by one of ordinary skill in the art given the teachings of the present principles provided herein.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for detecting anomalous communications, comprising:
simulating a network graph based on community and role labels of each node in the network graph based on one or more linking rules;
adjusting the community and role labels of each node based on differences between the simulated network graph and a true network graph;
repeating said simulating and adjusting until the simulated network graph converges to the true network graph to determine a final set of community and role labels; and
determining whether a network communication is anomalous based on the final set of community and role labels.

2. The method of claim 1, wherein adjusting the community and role labels of each node comprises determining a conditional distribution for each pair of nodes in a network graph based on a rate of linking for a community and role label of each node in the pair of nodes and a ratio of community and role labels of both nodes.

3. The method of claim 1, further comprising determining initial community and role labels for each of a plurality of nodes.

4. The method of claim 3, wherein determining initial community and role labels comprises randomly assigning a community and role label to each node.

5. The method of claim 1, wherein the true network graph is based on historical communications between the nodes.

6. The method of claim 1, wherein repeating said simulating and adjusting comprises determining a true adjacency matrix based on the true network graph and a synthetic adjacency matrix based on the simulated network graph.

7. The method of claim 6, wherein repeating said simulating and adjusting further comprises determining whether the simulated network graph has converged to the true network graph by determining a similarity of the synthetic adjacency matrix to the true adjacency matrix.

8. The method of claim 1, wherein determining whether a network communication is anomalous comprises determining a probability of the network communication taking place between an associated first node and second node based on the community and role labels of the respective first and second nodes.

9. The method of claim 1, further comprising automatically responding to a detected intrusion event, said response comprising one or more of blocking the network communication, restricting access, changing security policies, and alerting a system administrator.

10. A system for detecting anomalous communications, comprising:
a community and role detection module comprising a processor configured to simulate a network graph based on community and role labels of each node in the network graph based on one or more linking rules, to adjust the community and role labels of each node based on differences between the simulated network graph and a true network graph, and to repeat said simulation and adjustment until the simulated network graph converges to the true network graph to determine a final set of community and role labels; and
an anomaly detection module configured to determine whether a network communication is anomalous based on the final set of community and role labels.

11. The system of claim 10, wherein the community and role detection module is further configured to determine a conditional distribution for each pair of nodes in a network graph based on a rate of linking for a community and role label of each node in the pair of nodes and a ratio of community and role labels of both nodes.

12. The system of claim 10, wherein the community and role detection module is further configured to determine initial community and role labels for each of a plurality of nodes.

13. The system of claim 12, wherein the community and role detection module is further configured to randomly assign a community and role label to each node.

14. The system of claim 10, wherein the true network graph is based on historical communications between the nodes.

15. The system of claim 10, wherein the community and role detection module is further configured to determine a true adjacency matrix based on the true network graph and a synthetic adjacency matrix based on the simulated network graph.

16. The system of claim 15, wherein the community and role detection module is further configured to determine whether the simulated network graph has converged to the true network graph by determining a similarity of the synthetic adjacency matrix to the true adjacency matrix.

17. The system of claim 10, wherein the anomaly detection module is further configured to determine a probability of the network communication taking place between an associated first node and second node based on the community and role labels of the respective first and second nodes.

18. The system of claim 10, wherein the anomaly detection module is further configured to automatically responding to a detected intrusion event, said response comprising one or more of blocking the network communication, restricting access, changing security policies, and alerting a system administrator.
